(19) United States
(12) Patent Application Publication
(10) Pub. No.: US 2026/0269290 A1
(43) Pub. Date: Sep. 10, 2026

(54) FUEL CELL SYSTEM

(71) Applicant: Honda Motor Co., Ltd., Tokyo (JP)

(72) Inventor: Hikaru Watanabe, Saitama (JP)

(21) Appl. No.: 19/554,653

(22) Filed: Mar. 3, 2026

(30) Foreign Application Priority Data
Mar. 5, 2025 (JP) 2025-034640

(51) Int. Cl. H01M 8/04992; H01M 8/04082; H01M 8/0438; H01M 8/04746; H01M 8/10

(52) U.S. Cl. CPC H01M 8/04992; H01M 8/04201; H01M 8/04395; H01M 8/04753; H01M 8/04761; H01M 2008/1095

(57) ABSTRACT

A fuel cell system including a microprocessor controlling an anode gas supply and exhaust part and a cathode gas supply and exhaust part according to a required power. The cathode gas supply and exhaust part includes a first valve provided in a bypass flow path and a second valve provided in a cathode discharge flow path. The microprocessor is configured to perform gradually increasing a valve opening degree of the first valve and decreasing a valve opening degree of the second valve such that a pressure of the cathode gas in a cathode supply flow path gradually decreases when a degree of a decrease in the required power becomes equal to or greater than a predetermined degree.

### CROSS-REFERENCE TO RELATED APPLICATION

This application is based upon and claims the benefit of priority from Japanese Patent Application No. 2025-034640 filed on Mar. 5, 2025, the content of which is incorporated herein by reference.

### BACKGROUND OF THE INVENTION

### Field of the Invention

This invention relates to a fuel cell system.

### Description of the Related Art

In recent years, technological developments have been made on a fuel cell that contribute to energy efficiency to ensure access to energy that is affordable, reliable, sustainable and advanced by more people. As a technology related to this type of fuel cell, conventionally, a fuel cell system is known in which air supplied from a compressor is circulated through a bypass flow path without passing through the fuel cell. Such a system is described, for example, in Japanese Examined Patent Publication No. 6465307 (JP 6465307 B). In the fuel cell system described in JP 6465307 B, when the operating point of the compressor is within the near-surge operation region, a bypass valve provided in the bypass flow path is opened to reduce the pressure in the air supply flow path, and then the rotational speed of the compressor is reduced.

However, when the required power for the fuel cell system decreases at a rate equal to or greater than a predetermined rate, it is necessary to reduce the air supply amount by the rotation of the compressor, but the air supply amount cannot be reduced immediately. For this reason, more air than necessary is supplied to the fuel cell, and there is a risk that the fuel cell will dry out. To prevent this, it is conceivable to open the bypass valve to reduce the amount of air supplied to the fuel cell when the required power decreases at the rate equal to or greater than the predetermined rate. However, when the air supply amount is reduced, the differential pressure between the anode gas and the cathode gas increases, which may cause deterioration of the fuel cell.

### SUMMARY OF THE INVENTION

An aspect of the present invention is a fuel cell system including: a fuel cell that generates power by being supplied with an anode gas and a cathode gas; an anode gas supply and exhaust part configured to supply the anode gas to the fuel cell through an anode supply flow path, discharge the anode gas from the fuel cell through an anode discharge flow path, and circulate the anode gas from the anode discharge flow path to the anode supply flow path through a circulation flow path; a cathode gas supply and exhaust part configured to supply the cathode gas to the fuel cell through a cathode supply flow path, discharge the cathode gas from the fuel cell through a cathode discharge flow path, and bypass the cathode gas from the cathode supply flow path to the cathode discharge flow path through a bypass flow path; and an electronic control unit including a microprocessor and a memory connected to the microprocessor. The microprocessor is configured to perform controlling the anode gas supply and exhaust part and the cathode gas supply and exhaust part in accordance with a required power, the cathode gas supply and exhaust part includes a first valve provided in the bypass flow path and a second valve provided in the cathode discharge flow path, and the microprocessor is configured to perform the controlling including gradually increasing a valve opening degree of the first valve and decreasing a valve opening degree of the second valve such that a pressure of the cathode gas in the cathode supply flow path gradually decreases when a degree of a decrease in the required power becomes equal to or greater than a predetermined degree.

### BRIEF DESCRIPTION OF THE DRAWINGS

The objects, features, and advantages of the present invention will become clearer from the following description of embodiments in relation to the attached drawings, in which:

FIG. 1 is a diagram illustrating a schematic configuration of a fuel cell system according to an embodiment of the present invention;

FIG. 2 is a cross-sectional view of a main part of a fuel cell stack included in the fuel cell system in FIG. 1;

FIG. 3 is a block diagram illustrating a control configuration of the fuel cell system according to the embodiment of the present invention;

FIG. 4 is a time chart illustrating an example of an operation by a fuel cell system used as a reference example of the present embodiment;

FIG. 5 is a time chart illustrating an example of an operation by the fuel cell system according to the embodiment of the present invention;

FIG. 6 is a time chart illustrating another example of an operation by the fuel cell system according to the embodiment of the present invention; and

FIG. 7 is a flowchart illustrating an example of processing performed by a controller in FIG. 3.

### DETAILED DESCRIPTION OF THE INVENTION

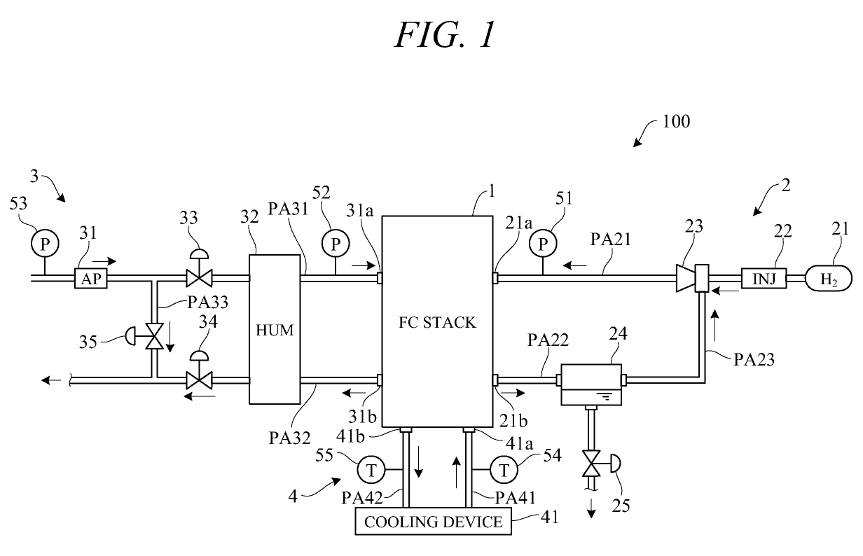

Hereinafter, an embodiment of the present invention will be described with reference to FIGS. 1 to 7. FIG. 1 is a diagram illustrating a schematic configuration of a fuel cell system 100 according to an embodiment of the present invention. The fuel cell system 100 of FIG. 1 is mounted on, for example, a vehicle (fuel cell vehicle) and generates electric power to be supplied to a travel motor of the vehicle.

As illustrated in FIG. 1, the fuel cell system 100 includes a fuel cell stack 1, a fuel gas supply and exhaust part 2 that supplies a fuel gas (anode gas) to the fuel cell stack 1 and discharges the fuel gas from the fuel cell stack 1, an oxidant gas supply and exhaust part 3 that supplies an oxidant gas (cathode gas) to the fuel cell stack 1 and discharges the oxidant gas from the fuel cell stack 1, and a cooling medium supply and exhaust part 4 that supplies a cooling medium to the fuel cell stack 1 and discharges the cooling medium from the fuel cell stack 1. The fuel gas is, for example, hydrogen. The oxidant gas is, for example, air containing oxygen. The cooling medium is, for example, water or a coolant liquid containing ethylene glycol or propylene glycol.

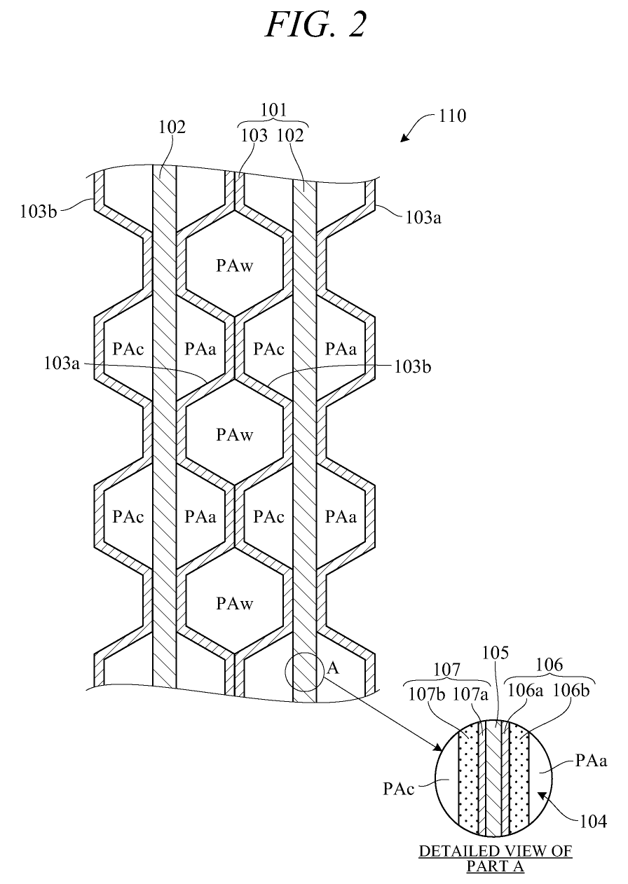

FIG. 2 is a cross-sectional view of a main part of the fuel cell stack 1. As illustrated in FIG. 2, the fuel cell stack 1 includes a cell stacked body 110 configured by stacking a plurality of power generation cells 101. The power generation cell 101 includes a unitized electrode assembly (UEA) 102 including a membrane electrode assembly (MEA) having an electrolyte membrane and electrodes, and a separator 103 alternately arranged with the unitized electrode assembly 102. The separator 103 integrally includes an anode separator 103a which is a plate member disposed facing one surface of the unitized electrode assembly 102, and a cathode separator 103b which is a plate member disposed facing the other surface of the unitized electrode assembly 102.

Inside the separator 103 enclosed by the anode separator 103a and the cathode separator 103b, a cooling flow path PAw through which a cooling medium flows is formed. The generating surface of the power generation cell 101 is cooled by the flow of the cooling medium. The surface of the separator 103 facing the unitized electrode assembly 102 is formed into an uneven shape by press molding or the like to form a gas flow path between the separator 103 and the unitized electrode assembly 102. An anode flow path PAa through which the fuel gas flows is formed in the recess between the unitized electrode assembly 102 and the anode separator 103a. A cathode flow path PAc through which the oxidant gas flows is formed in the recess between the unitized electrode assembly 102 and the cathode separator 103b.

FIG. 2 includes an enlarged cross-sectional view of the membrane electrode assembly 104 (detailed view of part “A”) as a cross-sectional view of the unitized electrode assembly 102. As illustrated in the detailed view of part “A” in FIG. 2, the membrane electrode assembly 104 has an electrolyte membrane 105, an anode electrode 106 provided on one surface of the electrolyte membrane 105, and a cathode electrode 107 provided on the other surface of the electrolyte membrane 105. The electrolyte membrane 105 is, for example, a solid polymer electrolyte membrane, and a thin film of perfluorosulfonic acid polymer containing moisture can be used. Not only a fluorine-based electrolyte but also a hydrocarbon-based electrolyte can be used.

The anode electrode 106 has an electrode catalyst layer 106a formed on one surface of the electrolyte membrane 105 and served as a reaction field for electrode reaction, and a gas diffusion layer 106b formed on the surface of the electrode catalyst layer 106a on the opposite side of the electrolyte membrane 105 to spread and supply the fuel gas. The cathode electrode 107 has an electrode catalyst layer 107a formed on the other surface of the electrolyte membrane 105 and served as a reaction field for electrode reaction, and a gas diffusion layer 107b formed on the surface of the electrode catalyst layer 107a on the opposite side of the electrolyte membrane 105 to spread and supply the oxidant gas. Intermediate layers (underlayers) can also be provided between the electrode catalyst layer 106a and 107a and the gas diffusion layer 106b and 107b.

The electrode catalyst layers 106a and 107a include a catalyst metal that promotes the electrochemical reaction of hydrogen contained in the fuel gas and oxygen contained in the oxidant gas, an electrolyte (such as an ionomer) with proton conductivity, and carbon particles with electron conductivity, and the like. The gas diffusion layers 106b and 107b are made of conductive members with gas permeability, such as carbon porous bodies. The gas diffusion layers 106b and 107b can retain the fuel gas and the oxidant gas.

In the anode electrode 106, the fuel gas (hydrogen) supplied through the anode flow path PAa is ionized by an action of a catalyst, passes through the electrolyte membrane 105, and moves to the cathode electrode side. Electrons generated at this time pass through an external circuit and are extracted as electric energy. In the cathode electrode 107, an oxidant gas (oxygen) supplied via the cathode flow path PAc reacts with hydrogen ions guided from the anode electrode 106 and electrons moved from the anode electrode 106 to generate water. The generated water gives an appropriate humidity to the electrolyte membrane 105, and excess water is discharged to an outside of the unitized electrode assembly 102 along the gas flow. The generated water on the cathode side also flows to the anode side by back diffusion through the electrolyte membrane 105. Therefore, both the fuel gas and oxidant gas contain generated water. Both the fuel gas and oxidant gas also contain condensed water.

As illustrated in FIG. 1, the fuel gas supply and exhaust part 2 includes a fuel gas tank 21 in which fuel gas (anode gas) is stored, a fuel gas supply flow path PA21 for guiding the fuel gas in the fuel gas tank 21 to the fuel gas inlet 21a of the fuel cell stack 1, and a fuel gas discharge flow path PA22 through which the fuel gas (fuel exhaust gas) discharged from the fuel gas outlet 21b of the fuel cell stack 1 flows. An injector 22 and an ejector 23 are arranged in the fuel gas supply flow path PA21. A gas-liquid separator 24 is connected to the fuel gas discharge flow path PA22.

The injector 22 is configured by a single electromagnetic injector or multiple electromagnetic injectors connected in parallel. The fuel gas is injected toward the ejector 23 by the operation of the injector 22. The ejector 23 includes a nozzle section, a suction section, a merging section, and a diffuser section. The fuel gas injected from the injector 22 passes through the small-diameter nozzle section and then flows into the diffuser section via the merging section. The fuel gas that has passed through the ejector 23 is supplied to the fuel cell stack 1 via the fuel gas inlet 21a.

The fuel gas discharged from the fuel gas outlet 21b, that is, the fuel exhaust gas (anode off-gas), is separated into fuel gas and water by the gas-liquid separator 24. The water separated by the gas-liquid separator 24 is discharged to the outside via an electromagnetic drain valve 25. The fuel gas separated by the gas-liquid separator 24 is guided to the circulation flow path PA23. The ejector 23 is connected to the circulation flow path PA23. Although not shown, a purge flow path is connected to the circulation flow path PA23, and the fuel gas in the circulation flow path PA23 can be discharged to the outside via the purge flow path.

In the ejector 23, the fuel gas separated by the gas-liquid separator 24 is sucked in via the circulation flow path PA23 by the flow of fuel gas injected from the injector 22. The sucked-in fuel gas merges with the fuel gas that has passed through the nozzle section of the ejector 23 at the merging section of the ejector 23, and after being made into a uniform flow in the diffuser section of the ejector 23, it is supplied to the fuel cell stack 1 via the fuel gas inlet 21a.

The oxidant gas supply and exhaust part 3 includes an electric air pump 31 that generates high-pressure oxidant gas (cathode gas), an oxidant gas supply flow path PA31 that guides the oxidant gas generated by the air pump 31 to the oxidant gas inlet 31a of the fuel cell stack 1, and an oxidant gas discharge flow path PA32 through which the oxidant gas (oxidant exhaust gas) discharged from the oxidant gas outlet 31b of the fuel cell stack 1 flows. The air pump 31 functions as a gas supply part that compresses air taken from the atmosphere to generate high-pressure oxidant gas. The air pump 31 may be referred as a compressor.

A humidifier 32 is arranged intersecting the oxidant gas supply flow path PA31 and the oxidant gas discharge flow path PA32. In the humidifier 32, a humidity exchange occurs between the oxidant gas and the oxidant exhaust gas, and the oxidant gas in the oxidant gas supply flow path PA31 is humidified by the moisture (water vapor) contained in the oxidant exhaust gas in the oxidant gas discharge flow path PA32.

The oxidant gas supply and exhaust part 3 further includes a bypass flow path PA33. The bypass flow path PA33 is connected to the oxidant gas supply flow path PA31 upstream of the humidifier 32 and the oxidant gas discharge flow path PA32 downstream of the humidifier 32. Through the bypass flow path PA33, the oxidant gas can flow bypassing the humidifier 32 and the fuel cell stack 1. The oxidant gas which has flowed through the bypass flow path PA33 is discharged to the outside via the oxidant gas discharge flow path PA32.

In the oxidant gas supply flow path PA31, an electromagnetic control valve 33 with adjustable opening is provided between the bypass flow path PA33 and the humidifier 32. In the oxidant gas discharge flow path PA32, an electromagnetic control valve 34 with adjustable opening is provided between the bypass flow path PA33 and the humidifier 32. In the bypass flow path PA33, an electromagnetic control valve 35 with adjustable opening is provided. By controlling the air pump 31 and the control valves 33 to 35, the supply amount and pressure of the oxidant gas supplied to the fuel cell stack 1 can be adjusted. Additionally, by controlling the control valves 33 to 35, the bypass amount of the oxidant gas bypassing the fuel cell stack 1 can be adjusted.

The cooling medium supply and exhaust part 4 includes a cooling device 41, a cooling medium supply flow path PA41 connecting the cooling device 41 and the cooling medium inlet 41a of the fuel cell stack 1, and a cooling medium discharge flow path PA42 connecting the cooling device 41 and the cooling medium outlet 41b of the fuel cell stack 1. Although not shown, the cooling device 41 includes a pump for pressurizing the cooling medium toward the fuel cell stack 1, a heat exchanger (radiator) for cooling the cooling medium that has been heated by passing through the fuel cell stack 1, and a cooling fan for blowing cooling air to the heat exchanger.

In the fuel gas supply flow path PA21, a pressure sensor 51 is connected downstream of the ejector 23. The pressure sensor 51 detects the inlet pressure (anode pressure Pa) of the fuel gas supplied to the fuel cell stack 1. In the oxidant gas supply flow path PA31, a pressure sensor 52 is connected downstream of the humidifier 32. The pressure sensor 52 detects the inlet pressure (cathode pressure Pc) of the oxidant gas supplied to the fuel cell stack 1. Furthermore, in the oxidant gas supply flow path PA31, a pressure sensor 53 is connected upstream of the air pump 31. The pressure sensor 53 detects the atmospheric pressure P0.

In the cooling medium supply flow path PA41, a temperature sensor 54 is connected to detect the temperature (cooling medium inlet temperature) of the cooling medium. In the cooling medium discharge flow path PA42, a temperature sensor 55 is connected to detect the temperature (cooling medium outlet temperature) of the cooling medium. The cooling medium inlet temperature and the cooling medium outlet temperature is sometimes referred to as merely a cooling medium temperature. The cooling medium temperature may be an average of the cooling medium inlet temperature and the cooling medium outlet temperature. The cooling medium temperature can be used as a temperature of reaction gas.

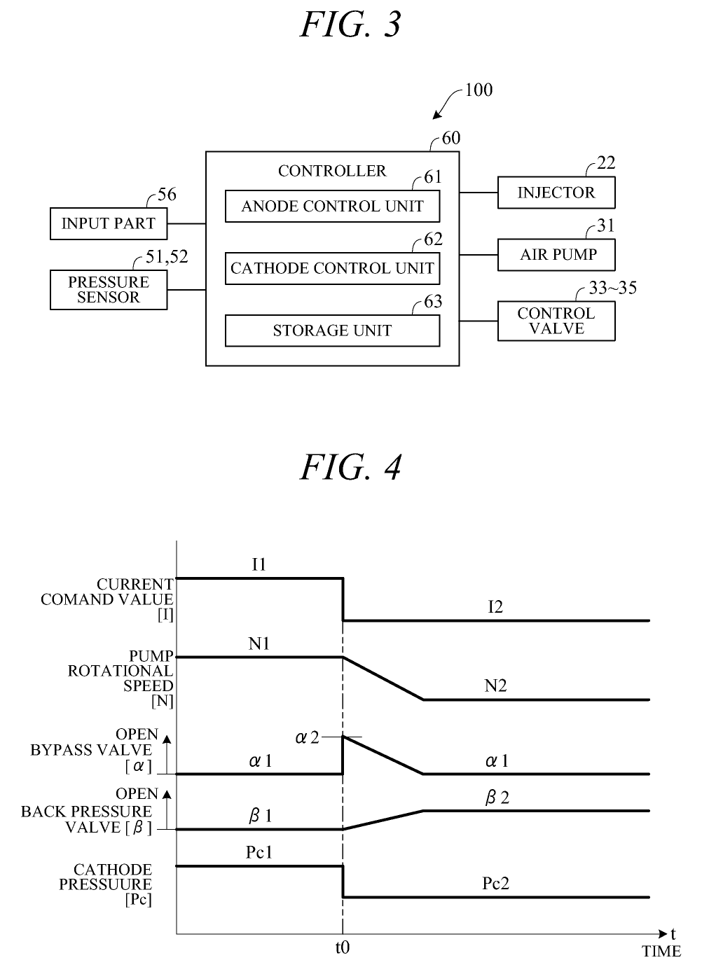

FIG. 3 is a block diagram illustrating a control configuration of the fuel cell system 100 according to the embodiment of the present invention. As illustrated in FIG. 3, the fuel cell system 100 includes a controller 60, and an input part 56, pressure sensors 51 and 52, an injector 22, an air pump 31, and control valves 33 to 35, which are connected to the controller 60.

The input part 56 inputs a command value for calculating required power (required power generation amount), and includes, for example, an accelerator opening sensor that detects an accelerator opening degree. That is, the controller 60 calculates target drive torque of the travel motor, based on a signal from the accelerator opening sensor, which detects an opening degree of the accelerator pedal, and calculates the required power necessary for the travel motor to generate the target drive torque. The controller 60 may calculate a required power generation amount instead of, or in addition to, the required power. The controller 60 further calculates a target current for satisfying the required power, and outputs a current command value corresponding to the target current. When acceleration is commanded by the operation of the accelerator pedal, that is, when the load rises, the current command value increases. When deceleration is commanded by the operation of the accelerator pedal, that is, when the load decreases, the current command value decreases. Therefore, a signal (command value) corresponding to the load is input from the input part 56.

A signal indicating the command value (accelerator opening degree) input by the input part 56, the anode pressure Pa detected by the pressure sensor 51, and the cathode pressure Pc detected by the pressure sensor 52 is input to the controller 60. Although not illustrated, signals from the pressure sensor 53 and the temperature sensors 54 and 55 are also input to the controller 60. The controller 60 executes predetermined processing based on these input signals, and outputs control signals to the injector 22, the air pump 31, and the control valves 33 to 35.

The controller 60 is a computer including an arithmetic processing device including a CPU, a ROM, a RAM, and other peripheral circuits. The controller 60 includes an anode control unit 61, a cathode control unit 62, and a storage unit 63 as functional components. Various maps, thresholds, arithmetic expressions, programs, and the like are stored in the storage unit 63.

The controller 60 calculates the required power based on the signal from the input part 56. The anode control unit 61 controls a fuel gas supply and exhaust part 2 according to the required power. More specifically, the anode control unit 61 calculates a target flow rate of the fuel gas corresponding to the required power, further calculates an anode target pressure corresponding to the target flow rate, and outputs a control signal to the injector 22 so that the fuel gas corresponding to the target flow rate is supplied to fuel cell stack 1. Accordingly, the anode pressure Pa detected by the pressure sensor 51 is controlled to the anode target pressure.

Similarly to the anode control unit 61, the cathode control unit 62 also controls an oxidant gas supply and exhaust part 3 according to the required power generation amount. More specifically, the cathode control unit 62 calculates a target flow rate of the oxidant gas, further calculates a cathode target pressure corresponding to the required power, and outputs a control signal to the air pump 31 and the control valves 33 to 35 such that the oxidant gas corresponding to the target flow rate is supplied to the fuel cell stack 1. Accordingly, the cathode pressure Pc detected by the pressure sensor 52 is controlled to the cathode target pressure. The control valve 34 adjusts the cathode pressure Pc, and hereinafter may be referred to as a back pressure valve. The control valve 35 adjusts a bypass amount of the oxidant gas, and hereinafter, may be referred to as a bypass valve.

The present embodiment is characterized in the control content of the cathode control unit 62 in a case where the current command value decreases due to a deceleration command or the like, particularly, in a case where the current command value decreases at a decrease rate of a predetermined degree or more. This point will be described below. First, a reference example of the present embodiment will be described. FIG. 4 is a time chart illustrating an example of the operation by the fuel cell system as a reference example of the present embodiment. That is, FIG. 4 is a diagram illustrating changes with the lapse of time in a current command value I, a rotational speed (pump rotational speed) N of the air pump 31, an opening degree α of the bypass valve 35, an opening degree β of the back pressure valve 34, and the cathode pressure Pc. The pump rotational speed N has a correlation with the supply amount of the oxidant gas, and the supply amount of the oxidant gas increases as the pump rotational speed N increases.

As illustrated in FIG. 4, for the pump rotational speed N, until the current command value I rapidly decreases at time point t0, the pump rotates at a predetermined rotational speed N1 corresponding to the current command value I1. At this time, the bypass valve 35 is closed (valve opening degree α1), and the back pressure valve 34 is open at a predetermined opening degree β1. The cathode pressure Pc in this case is equal to a cathode target pressure Pc1 corresponding to the predetermined rotational speed N1 of the air pump 31.

When the current command value rapidly decreases from I1 to I2 at time point t0, the air pump 31 cannot rapidly decrease the supply amount of the oxidant gas, and the pump rotational speed N gradually decreases to a rotational speed N2 corresponding to a current command value I2. Therefore, a larger amount of oxidant gas than the target flow rate is supplied to the fuel cell stack 1, and the fuel cell stack 1 may be dried so that the power generation performance decreases. In order to avoid this, in the reference example, when a difference from the target flow rate becomes a predetermined value or more at time point t0, the bypass valve 35 is immediately opened (rapidly opened). Accordingly, the oxidant gas supplied from the air pump 31 flows through the bypass valve 35, and the cathode pressure Pc immediately decreases to a cathode target pressure Pc2. At this time, the back pressure valve 34 is gradually opened, and the valve opening degree becomes β2.

By opening the bypass valve 35 in this manner, the cathode pressure Pc can be immediately decreased according to the current command value I. On the other hand, since the fuel gas circulates through a circulation flow path PA23, the anode pressure Pa cannot be immediately decreased even when the injection from the injector 22 is stopped. Therefore, when cathode pressure Pc is rapidly decreased as in the reference example, a differential pressure between the anode pressure Pa and the cathode pressure Pc increases, which may cause degradation of the fuel cell stack 1. In consideration of this point, in the present embodiment, when the current command value I rapidly decreases, the oxidant gas supply and exhaust part 3 is controlled as follows.

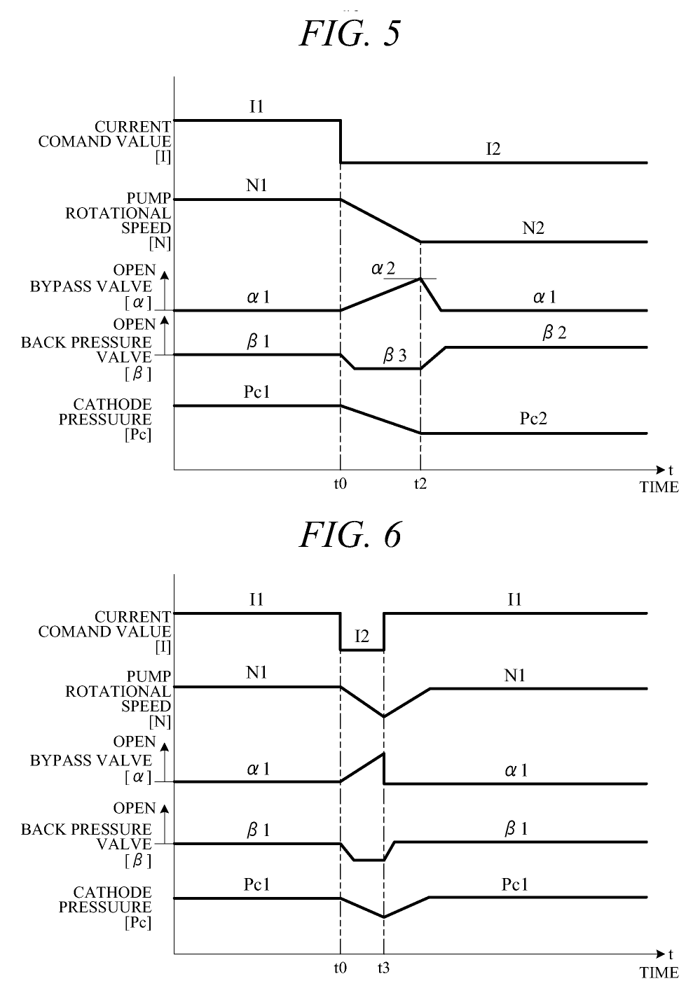

FIG. 5 is a time chart illustrating an example of an operation by the fuel cell system 100 according to the present embodiment. As illustrated in FIG. 5, the operation up to time point t0 is the same as that in the reference example of FIG. 4. When the current command value I rapidly decreases from I1 to I2 at time point t0, the cathode control unit 62 outputs a control signal to the air pump 31, and gradually decreases the pump rotational speed N to the rotational speed N2 corresponding to the current command value I2 as in the reference example. At this time, the cathode control unit 62 outputs a control signal to the bypass valve 35, and gradually increases the valve opening degree α unlike the reference example. Further, the cathode control unit 62 outputs a control signal to the back pressure valve 34, and gradually decreases the valve opening degree β until reaching the predetermined opening degree β3. The predetermined opening degree β3 is, for example, 0, the back pressure valve 34 becomes in a fully closed state during the opening operation of the bypass valve 35, and thereafter, the fully closed state is maintained until the cathode pressure Pc reaches the cathode target pressure Pc2.

By gradually opening the bypass valve 35 in this manner, the cathode pressure Pc does not decrease rapidly but decreases gently. Accordingly, it is possible to suppress the rise in the differential pressure between the anode pressure Pa and the cathode pressure Pc. When bypass valve 35 is gradually opened, the oxidant gas may be excessively supplied to the fuel cell stack 1. However, since back pressure valve 34 is closed, the oxidant gas hardly flows through the fuel cell stack 1. Accordingly, it is possible to suppress the amount of oxidant gas supplied to the fuel cell stack 1, and to prevent the fuel cell stack 1 from being dried.

Thereafter, at time point t2, when the pump rotational speed N decreases to a predetermined rotational speed N2 and the cathode pressure Pc reaches the cathode target pressure Pc2, the bypass valve 35 is gradually closed, and the valve opening degree decreases from α2 to α1. At this time, the back pressure valve 34 is gradually opened, and the valve opening degree β becomes β2. The valve opening degree of α2 is set based on the cathode target pressure. The lower the cathode target pressure, the larger the valve opening degree of α2 is set. At this time, α2 may be an opening degree corresponding to the fully open state.

FIG. 6 is a time chart illustrating another example of the operation by the fuel cell system 100 according to the present embodiment. FIG. 6 is an example of an operation in a case where the current command value I rapidly decreases from I1 to I2 and then rapidly increases to I1 at time point t3 before time point t2. As illustrated in FIG. 6, the operation up to time point t3 is the same as that in FIG. 5.

At time point t3, for example, when the accelerator pedal is depressed again and the current command value I rapidly rises from I2 to I1, the cathode control unit 62 outputs a control signal to the air pump 31 to gradually increase the pump rotational speed N to a predetermined rotational speed N1. At this time, the cathode control unit 62 outputs a control signal to the bypass valve 35 to immediately close the bypass valve 35 (valve opening degree α1). In addition, the cathode control unit 62 outputs a control signal to the back pressure valve 34, and gradually increases the valve opening degree β to the predetermined opening degree β1. Accordingly, the cathode pressure Pc rapidly rises to the cathode target pressure Pc1.

After the rapid deceleration of the vehicle is commanded in this manner, when re-acceleration is commanded before the pump rotational speed N decreases to the predetermined rotational speed N2, the bypass valve 35 is immediately closed. Accordingly, a necessary amount of oxidant gas can be immediately supplied to the fuel cell stack 1, and responsiveness is favorable.

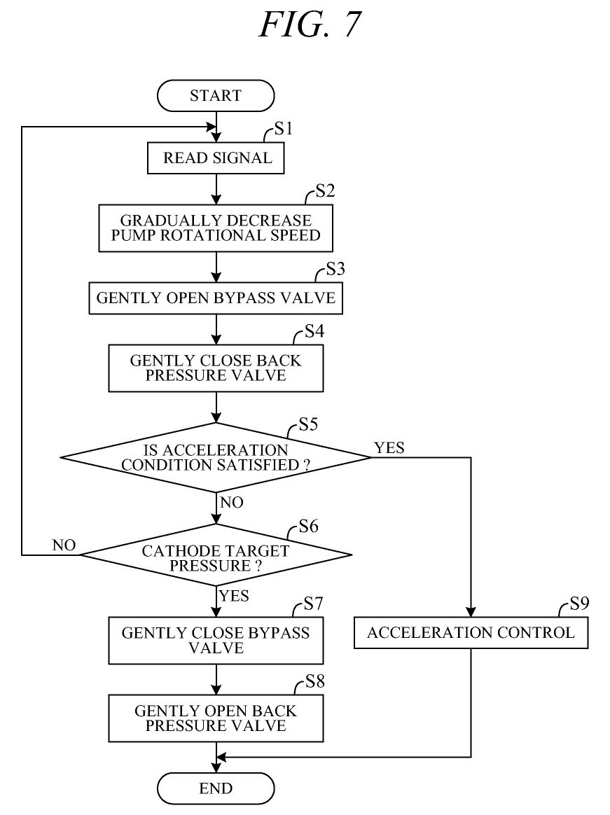

FIG. 7 is a flowchart illustrating an example of processing executed by the controller 60, particularly, an example of deceleration processing of the cathode control unit 62. The processing illustrated in this flowchart is started, for example, when a deceleration condition is satisfied. The deceleration condition is satisfied when the degree of decrease in the current command value I is equal to or greater than a predetermined degree. Specifically, the condition is satisfied when the current command value I decreases by a predetermined value or more within a predetermined time and the decrease rate of the current command value I is large, that is, when the decrease rate of the current command value I is greater than or equal to a predetermined value, in other word, the current command value I rapidly decreases. As illustrated in FIGS. 5 and 6, when the current command value I rapidly decreases from I1 to I2, the deceleration condition is satisfied. Therefore, the controller 60 executes the flowchart of FIG. 7 to obtain the operations of FIGS. 5 and 6. Hereinafter, for convenience, the flowchart of FIG. 7 will be described with reference to the numerical values of FIGS. 5 and 6.

When the current command value I decreases from I1 to I2 at time point t0 in FIG. 5 and the deceleration condition is satisfied, the controller 60 (cathode control unit 62) reads signals from the input part 56 and the pressure sensors 51 and 52 in S1 (S: processing step) as illustrated in FIG. 7. Next, in S2, the controller 60 outputs a control signal to the air pump 31 and gradually decreases the pump rotational speed N to the rotational speed N2 corresponding to the current command value I2 as illustrated in FIG. 5. That is, the pump rotational speed N is gradually decreased.

Next, in S3, the controller 60 outputs a control signal to the bypass valve 35 and gradually increases the valve opening degree α as illustrated in FIG. 5. That is, the bypass valve 35 is gently opened. Next, in S4, the controller 60 outputs a control signal to the back pressure valve 34 and gradually decreases the valve opening degree β. That is, the back pressure valve 34 is gently closed. In this case, when the valve opening degree β decreases to the predetermined opening degree β3 (for example, 0), the valve opening degree β is maintained at the predetermined opening degree β3. A magnitude (absolute value) of the valve opening speed of the bypass valve 35 and a magnitude (absolute value) of the valve closing speed of the back pressure valve 34 at this time are set such that, for example, the change amounts (absolute value) per unit time are equal to each other.

Next, in S5, it is determined whether or not the acceleration condition is satisfied. The acceleration condition is satisfied when the degree of rise in the current command value I is equal to or greater than a predetermined degree. Specifically, the condition is satisfied when the current command value I rises by a predetermined value or more within a predetermined time and the rise rate of the current command value I is large, that is, when the rise rate of the current command value I is equal to or greater than a predetermined value, in other word, the current command value I rapidly increases. Therefore, the acceleration condition is satisfied at time point t3 in FIG. 6. When a negative determination is made in S5, the processing proceeds to S6, and the controller 60 determines whether or not the cathode pressure Pc has decreased to the cathode target pressure Pc2 corresponding to the current command value I2. When an affirmative determination is made in S6, the processing proceeds to S7, and when a negative determination is made, the processing returns to S1.

In S7, the controller 60 outputs a control signal to the bypass valve 35, and gradually closes the bypass valve 35 as illustrated after time point t2 in FIG. 5. That is, the bypass valve 35 is gently closed. The magnitude of the valve closing speed of the bypass valve 35 at this time is faster than the magnitude of the valve opening speed of the bypass valve 35 in S3. Next, in S8, the controller 60 outputs a control signal to the back pressure valve 34, and gradually opens the back pressure valve 34 to the value β2 corresponding to the current command value I2. That is, the back pressure valve 34 is gently opened. By the deceleration processing described above, the cathode pressure Pc gradually decreases as the pump rotational speed N decreases. The valve closing speed of the bypass valve 35 and the valve opening speed of the back pressure valve 34 at this time may be set such that the magnitude of the change amounts per unit time are equal to each other, or may be set such that the magnitude of the valve opening speed of the back pressure valve 34 is larger than the magnitude of the valve closing speed of the bypass valve 35.

On the other hand, when an affirmative determination is made in S5, the processing proceeds to S9, and the controller 60 executes acceleration control. Specifically, the controller 60 outputs a control signal to the bypass valve 35, and immediately closes the bypass valve 35 as illustrated at time point t3 in FIG. 6. Further, the controller 60 outputs a control signal to the air pump 31 and gradually raises the pump rotational speed N, and outputs a control signal to the back pressure valve 34 and gradually opens the back pressure valve 34. Accordingly, the cathode pressure Pc rapidly increases. At this time, control for bringing the back pressure valve 34 into the fully open state may be performed simultaneously with immediately closing the bypass valve 35.

According to the present embodiment, the following operations and effects are achievable.

(1) A fuel cell system 100 includes: a fuel cell stack 1 (fuel cell) that is supplied with fuel gas (anode gas) and oxidant gas (cathode gas) to generate power; a fuel gas supply and exhaust part (anode gas supply and exhaust part) 2 that is configured to supply the fuel gas to the fuel cell stack 1 through a fuel gas supply flow path (anode supply flow path) PA21 and discharge the fuel gas from the fuel cell stack 1 through a fuel gas discharge flow path (anode discharge flow path) PA22, and circulate the fuel gas from the fuel gas discharge flow path PA22 to the fuel gas supply flow path PA21 through a circulation flow path PA23; an oxidant gas supply and exhaust part (cathode gas supply and exhaust part) 3 that is configured to supply the oxidant gas to the fuel cell stack 1 through an oxidant gas supply flow path (cathode supply flow path) PA31 and discharge the oxidant gas from the fuel cell stack 1 via an oxidant gas discharge flow path (cathode discharge flow path) PA32, and bypass the oxidant gas from the oxidant gas supply flow path PA31 to the oxidant gas discharge flow path PAb through a bypass flow path PA33; and a controller 60 that controls the fuel gas supply and exhaust part 2 and the oxidant gas supply and exhaust part 3 according to required power (FIGS. 1 and 3). The oxidant gas supply and exhaust part 3 includes a bypass valve 35 provided in the bypass flow path PA33 and a back pressure valve 34 provided in the oxidant gas discharge flow path PA32 (FIG. 1). When the required power decreases by a predetermined degree or more, the controller 60 gradually increases the valve opening degree α of the bypass valve 35 and decreases the valve opening degree β of the back pressure valve 34, such that the cathode pressure Pc, which is the pressure of the oxidant gas in the oxidant gas supply flow path PA31, gradually decreases (FIGS. 5 and 7).

With this configuration, when current command value I rapidly decreases, a bypass amount of the oxidant gas bypassing the fuel cell stack 1 gradually increases, so that an increase in a differential pressure between the fuel gas and the oxidant gas can be suppressed, and degradation of fuel cell stack 1 can be suppressed. In addition, the valve opening degree β of the back pressure valve 34 is made smaller as the increase rate of the bypass amount of the oxidant gas is made smaller than that in the reference example (FIG. 4), so that it is possible to suppress drying of the fuel cell stack 1 and to obtain favorable power generation performance.

(2) The controller 60 adjusts the valve opening speed of the bypass valve 35 and the valve closing speed of the back pressure valve 34 according to the degree of decrease in the required power (FIG. 5). Accordingly, the oxidant gas can be optimally bypassed according to the required power, and an increase in the differential pressure between the fuel gas and the oxidant gas can be favorably suppressed.

(3) The controller 60 increases the valve opening degree α of the bypass valve 35 at a predetermined valve opening speed when the required power decreases by a predetermined degree or more, and then decreases the valve opening degree α of the bypass valve 35 at a valve closing speed higher than the predetermined valve opening speed when the required power rises (FIGS. 5 and 7). Accordingly, when re-acceleration is commanded after the deceleration command, the vehicle can be accelerated with excellent responsiveness.

(4) The oxidant gas supply and exhaust part 3 further includes an air pump 31 that supplies the oxidant gas to the oxidant gas supply flow path PA31 by rotational driving (FIG. 1). When the required power decreases by a predetermined degree or more, the controller 60 gradually decreases a rotational speed N of the air pump 31 (FIGS. 5 and 7). Accordingly, the rotational speed N of the air pump 31 can be changed according to the decrease rate of the cathode target pressure.

The above embodiment can be modified to various forms. Hereinafter, some modified examples will be described. In the above embodiment, the bypass valve 35 is provided as a first valve in the bypass flow path PA33 of the oxidant gas supply and exhaust part 3, and the back pressure valve 34 is provided as a second valve in the oxidant gas discharge flow path PA32, and when the required power decreases by a predetermined degree or more, the valve opening degree α of the bypass valve 35 is gradually increased and the valve opening degree β of the back pressure valve 34 is decreased so that the cathode pressure Pc gradually decreases. More specifically, the valve opening speed of the bypass valve 35 and the valve closing speed of the back pressure valve 34 are adjusted according to the degree of decrease in the required power. However, as long as the valve opening degree of the first valve is gradually increased and the valve opening degree of the second valve is decreased such that the pressure of the cathode gas in the cathode supply flow path gradually decreases when the degree of decrease of the required power becomes equal to or greater than a predetermined degree, the configuration of the controller 60 as a control unit is not limited to that described above.

In the above embodiment, in a case where the required power increases after the required power decreases by a predetermined degree or more, the valve opening speed (a first speed) of the bypass valve 35 when the required power decreases is made small and the valve closing speed (a second speed) of the bypass valve 35 when the required power increases is made large. However, as long as the second speed is faster than the first speed, the first speed and the second speed are not limited to those described above. In the above embodiment, the air pump 31 is provided as a cathode supply part, and when the required power decreases by a predetermined degree or more, the controller 60 gradually decreases the rotational speed of the air pump 31, but the configuration of the cathode supply part is not limited to that described above.

In the above example, the fuel cell system 100 was explained in the context of its application to a fuel cell vehicle, but the fuel cell system of this invention can also be applied to other than fuel cell vehicles.

The above embodiment can be combined as desired with one or more of the above modifications. The modifications can also be combined with one another.

According to the present invention, high power generation performance can be obtained while suppressing an increase in the differential pressure between the anode gas and the cathode gas.

Above, while the present invention has been described with reference to the preferred embodiments thereof, it will be understood, by those skilled in the art, that various changes and modifications may be made thereto without departing from the scope of the appended claims.

What is claimed is:

1. A fuel cell system comprising:
a fuel cell that generates power by being supplied with an anode gas and a cathode gas;
an anode gas supply and exhaust part configured to supply the anode gas to the fuel cell through an anode supply flow path, discharge the anode gas from the fuel cell through an anode discharge flow path, and circulate the anode gas from the anode discharge flow path to the anode supply flow path through a circulation flow path;
a cathode gas supply and exhaust part configured to supply the cathode gas to the fuel cell through a cathode supply flow path, discharge the cathode gas from the fuel cell through a cathode discharge flow path, and bypass the cathode gas from the cathode supply flow path to the cathode discharge flow path through a bypass flow path; and
an electronic control unit including a microprocessor and a memory connected to the microprocessor, wherein
the microprocessor is configured to perform
controlling the anode gas supply and exhaust part and the cathode gas supply and exhaust part in accordance with a required power,
the cathode gas supply and exhaust part includes a first valve provided in the bypass flow path and a second valve provided in the cathode discharge flow path, and
the microprocessor is configured to perform
the controlling including gradually increasing a valve opening degree of the first valve and decreasing a valve opening degree of the second valve such that a pressure of the cathode gas in the cathode supply flow path gradually decreases when a degree of a decrease in the required power becomes equal to or greater than a predetermined degree.

2. The fuel cell system according to claim 1, wherein
the microprocessor is configured to perform
the controlling including adjusting a valve opening speed of the first valve and a valve closing speed of the second valve in accordance with the degree of the decrease in the required power.

3. The fuel cell system according to claim 1, wherein
the microprocessor is configured to perform
the controlling including increasing the valve opening degree of the first valve at a first speed when the degree of the decrease in the required power becomes equal to or greater than the predetermined degree, and when the required power increases after increasing the valve opening degree of the first valve, decreasing the valve opening degree of the first valve at a second speed faster than the first speed.

4. The fuel cell system according to claim 1, wherein
the cathode gas supply and exhaust part further includes a cathode supply part that supplies the cathode gas to the cathode supply flow path by a rotational drive, and
the microprocessor is configured to perform
the controlling including gradually decreasing a rotational speed of the cathode supply part when the degree of the decrease in the required power becomes equal to or greater than the predetermined degree.

5. The fuel cell system according to claim 1, further comprising
a pressure detection part that detects a pressure of the cathode gas in the cathode supply flow path, wherein
the microprocessor is configured to perform
the controlling including decreasing the valve opening degree of the second valve to a predetermined opening degree when the degree of the decrease in the required power becomes equal to or greater than the predetermined degree, and after decreasing the valve opening degree of the second valve to the predetermined opening degree, maintaining the valve opening degree of the second valve at the predetermined opening degree until the pressure of the cathode gas detected by the pressure detection part decreases to a predetermined pressure.

6. The fuel cell system according to claim 5, wherein
the microprocessor is configured to perform
the controlling including gradually decreasing the valve opening degree of the first valve and gradually increasing the valve opening degree of the second valve when the pressure of the cathode gas detected by the pressure detection part decreases to the predetermined pressure after the degree of the decrease in the required power becomes equal to or greater than the predetermined degree or more.

7. The fuel cell system according to claim 1, wherein
the anode gas supply and exhaust part includes an ejector disposed in the anode supply flow path so as to circulate the anode gas to the anode supply flow path through the circulation flow path.
